(19) United States
(12) Patent Application Publication
(10) Pub. No.: US 2014/0008929 A1
(43) Pub. Date: Jan. 9, 2014

(54) VACUUM GRIPPER DEVICE

(71) Applicant: Ho-Young Cho, Seoul (KR)

(72) Inventor: Ho-Young Cho, Seoul (KR)

(73) Assignee: KOREA PNEUMATIC SYSTEM CO., LTD., Seoul (KR)

(21) Appl. No.: 14/006,657

(22) PCT Filed: Feb. 16, 2012
(86) PCT No.: PCT/KR2012/001155

§ 371 Date: Sep. 20, 2013

(30) Foreign Application Priority Data
Mar. 31, 2011 (KR) 10-2011-0029262

(51) Int. Cl. B25J 15/06

(52) U.S. Cl. CPC B25J 15/0616
USPC 294/185; 294/188

(57) ABSTRACT

The present invention relates to a vacuum gripper device used in a vacuum transfer system. The device of the present invention includes a vacuum pump that is directly embedded in a negative pressure chamber of a gripper main body, wherein the gripper main body is designed with a configuration for supporting and operating the vacuum pump, such as a first hole and a second hole connected to an inlet and an outlet of the vacuum pump. Here, the vacuum pump is preferably supported by a fixing block provided inside the negative pressure chamber. The present invention does not cause any vacuum loss during the operation of the vacuum pump, and forms a desired level of vacuum pressure quickly. In addition, the vacuum gripper device of the present invention can be designed compactly and safely although the device includes the vacuum pump.

### TECHNICAL FIELD

The present relates, in general, to a vacuum gripper device and, more particularly, to a suction gripper device that is used to hold an object in a vacuum transfer system.

### BACKGROUND ART

Generally, a vacuum transfer system includes a vacuum pump, a hollow type gripper and a connection line that connects the two elements to each other. When the vacuum transfer system is configured such that the two elements are placed at respective locations remote from each other by a predetermined distance, a hose or a pipe may be used as the connection line. However, when the vacuum transfer system is configured such that the vacuum pump is directly placed on the upper surface of a gripper, an exhaust hole that is formed on the upper surface of the gripper may be used as the connection line.

In an operation of the vacuum transfer system, compressed air is supplied at a high speed into the vacuum pump through an inlet provided at a first end of the vacuum pump and is discharged to the atmosphere through an outlet provided at a second end of the vacuum pump, with the object to be transferred being in close contact with the lower surface of the gripper. During the above-mentioned process, interior air of the gripper is introduced into the vacuum pump through the connection line and is discharged to the atmosphere together with the compressed air. In the above state, a negative pressure is generated in the gripper, so the object is attached to the lower surface of the gripper by the suction force produced by the negative pressure.

When the gripper holds the object as described above, the vacuum transfer system can transfer the object to a predetermined desired location using a robot mechanism. In the related art vacuum transfer system having both the vacuum pump and the gripper, the vacuum pump and the gripper can effectively hold an object so as to allow the object to be transferred to a desired place, so the vacuum transfer system may be effectively used. However, the related art vacuum transfer system is problematic as follows.

First, the vacuum pump and the gripper are configured such that they are connected to each other and are operated in conjunction with each other via a connection line, so some vacuum loss is inevitably generated in the system due to the shape and length of the connection line. This means that, to form a desired vacuum or a desired negative pressure, the system is required to consume excessive energy and excessive time, so the system cannot be realized economically.

Second, in the system, the vacuum pump is exposed outside, so the system is problematic in that the vacuum pump may be easily broken due to shock and may easily cause a vacuum loss. This reduces the vacuum suction force relative to the object to be transferred, thereby deteriorating the work efficiency of the system.

In an effort to overcome the above-mentioned problems, a dome-shaped casing that covers the vacuum pump has been proposed. However, the casing increases the size of the system, causes a reduction in the vacuum efficiency due to an additional exhaust space, and makes the connection of the vacuum pump to the gripper difficult, so the proposal of the dome-shaped casing is not a reasonable solution that can efficiently solve the problems.

### DISCLOSURE

### Technical Problem

Accordingly, the present invention has been made keeping in mind the above problems occurring in the related art vacuum transfer system, and proposes a technique capable of overcoming the problems of the related art vacuum transfer system. Accordingly, an object of the present invention is to provide a vacuum gripper device that can solve the problem of a vacuum loss and can quickly form a desired level of vacuum pressure. Another object of the present invention is to provide a vacuum gripper device that is designed compactly and can be operated efficiently while protecting a vacuum pump from external shock.

### Technical Solution

In order to accomplish the above objects, the present invention provides a vacuum gripper device including a vacuum pump directly embedded in a negative pressure chamber of a gripper main body, wherein the gripper main body is configured such that it can efficiently support and operate the vacuum pump.

Described in detail, the vacuum gripper device of the present invention comprises:

a gripper main body forming therein a negative pressure chamber by being combined with a suction plate, wherein a first hole and a second hole are formed in an upper surface of the gripper main body at respective locations spaced apart from each other such that the first and second holes communicate with the negative pressure chamber;

a vacuum pump operated by compressed air supplied thereto at a high speed, and installed in the negative pressure chamber in such a way that an inlet and an outlet of the vacuum pump are connected to the first and second holes of the gripper main body, respectively, wherein the vacuum pump directly communicates with the negative pressure chamber through a through hole formed in a sidewall of the vacuum pump; and

the suction plate forming a lower surface of the negative pressure chamber, with a plurality of suction holes formed in a surface of the suction plate such that the suction holes communicate with the negative pressure chamber.

The vacuum gripper device may further include: fixing blocks provided on opposite ends of the negative pressure chamber so as to support an inlet end and an outlet end of the vacuum pump.

Further, each of the fixing blocks may be provided with a passage channel, a first end of which is connected to the inlet or to the outlet of the vacuum pump, and a second end of which is connected to the first hole or to the second hole of the gripper main body. When the first and second holes are formed in the upper surface of the gripper main body, the passage channel of each of the fixing blocks may be formed as an L-shaped passage channel.

### Advantageous Effects

The vacuum gripper device of the present invention is advantageous in that the device includes the vacuum pump, wherein the vacuum pump is directly embedded in the negative pressure chamber of the gripper main body, and is supported by a fixing block, so the present invention does not cause any vacuum loss during the operation of the vacuum pump, and can form a desired level of vacuum pressure quickly. In addition, the vacuum gripper device of the present invention can be designed compactly and safely, and can be operated efficiently although the device includes the vacuum pump.

### DESCRIPTION OF DRAWINGS

FIG. 1 is a perspective view of a vacuum gripper device according to the present invention;

FIG. 2 is an exploded perspective of FIG. 1;

FIG. 3 is a sectional view taken along A-A of FIG. 1; and

FIG. 4 is a view illustrating the operation of the vacuum gripper device according to the present invention.

### DESCRIPTION OF THE REFERENCE NUMERALS IN THE DRAWINGS

| | |
|---|---|
| 100: vacuum gripper device | |
| 10: gripper main body | 11: first hole |
| 12: second hole | 13: locking bolt |
| 14: sensor | 15: connector |
| 16: bracket | 17: the recessed part |
| 20: vacuum pump | 21: body |
| 22, 23, 24: nozzles | 25: through hole |
| 26: check valve | 27: inlet |
| 28: outlet | 29: silencer |
| 30: suction plate | 31: suction holes |
| 40: fixing block | 41: passage channel |
| C: negative pressure chamber | |
| P: object to be transferred | |

### BEST MODE

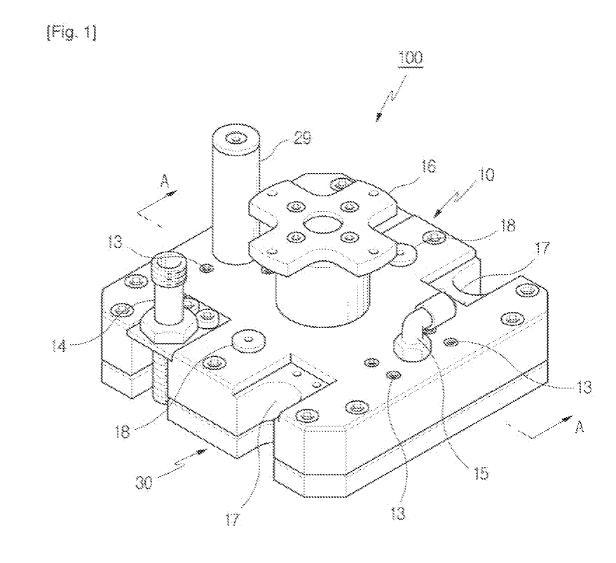

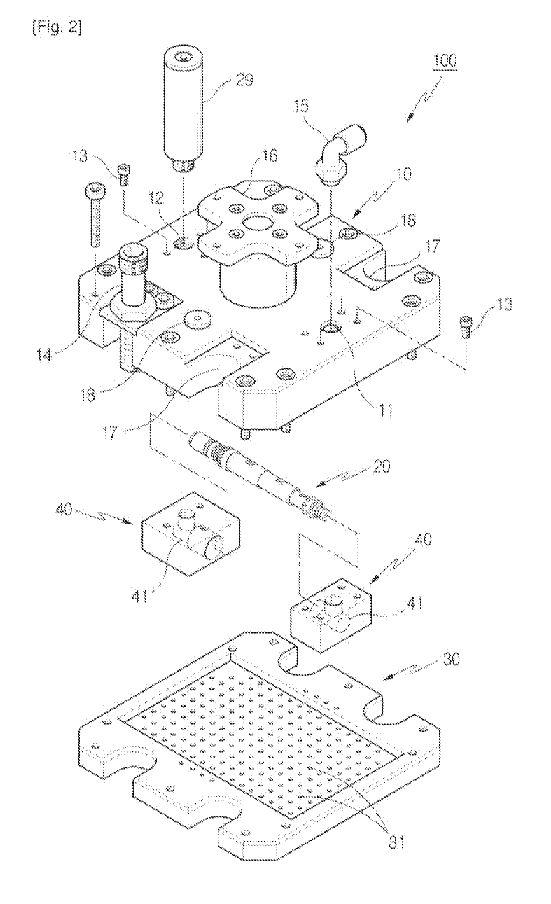

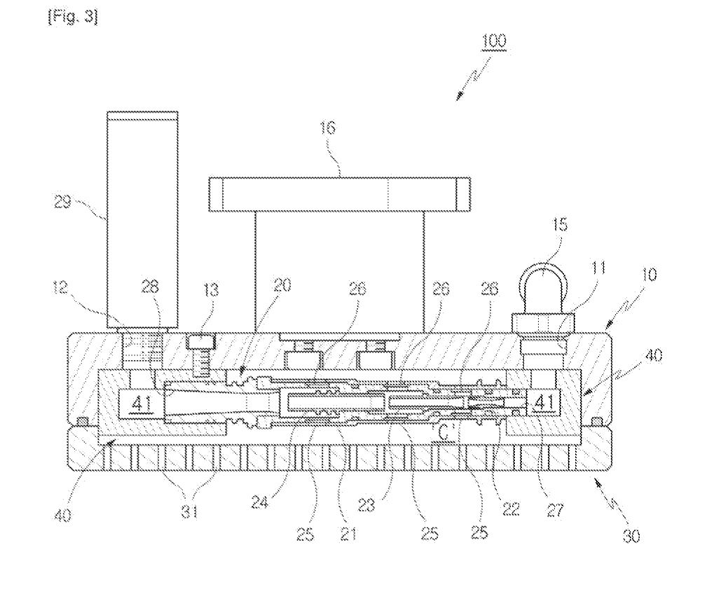

The above and other objects, features and other advantages of the present invention will be more clearly understood from the following detailed description of an embodiment when taken in conjunction with the accompanying drawings. In FIGS. 1 to 4, reference numeral 100 denotes a vacuum gripper device according to the present invention.

As shown in FIGS. 1 to 3, the vacuum gripper device 100 of the present invention comprises a gripper main body 10 that forms a negative pressure chamber C in cooperation with a suction plate 30, a vacuum pump 20 that is organically embedded in the negative pressure chamber C of the gripper main body 10, and the suction plate 30 that is mounted to the gripper main body 10 so as to form the lower surface of the negative pressure chamber C.

The gripper main body 10 is an element that is combined with the lower suction plate 30 and forms the negative pressure chamber C between them. Here, a first hole 11 and a second hole 12 that communicate with the negative pressure chamber C are formed in the upper surface of the gripper main body 10 at respective locations spaced apart from each other. The two holes 11 and 12 and elements 13, 15, 16 and 29 are formed in or mounted to the upper surface of the gripper main body 10. Because the present invention uses the upper surface of the gripper main body 10 as the base of the holes and elements, the present invention can avoid an increase in the size of the planar area of the gripper device 100.

Further, the side surface of the gripper main body 10 is provided with at least one recessed part 17, so desired parts can be safely installed in the gripper main body 10. In the present embodiment, a sensor 14 that can detect the approach or contact of an object to be transferred is provided in the recessed part 17. In the drawings, reference numeral 16 denotes a kind of bracket that is mounted to the upper surface of the gripper main body 10 and is used as a locking means for locking the gripper device 100 to a transfer unit, such as a robot arm.

Reference numeral 18 denotes a removable hole plug. For example, another space (not shown) that requires an exhaust of air may be connected to the negative pressure chamber C through the hole after removing the hole plug.

The vacuum pump 20 is a typical ejector pump that is operated by compressed air supplied thereto at a high speed. The vacuum pump 20 used in the present invention comprises a cylindrical body 21, and a plurality of nozzles 22, 23 and 24 that are arranged in the body 21 in series, with a through hole 25 formed in the sidewall of the body 21 such that the vacuum pump 20 communicates with the negative pressure chamber C through the through hole 25. A check valve 26 that is made of a flexible material is provided in the through hole 25, thus preventing a reverse flow of air through the through hole 25. Here, an inlet 27 and an outlet 28 are formed in opposite ends of the vacuum pump 20.

However, it should be understood that the construction of the vacuum pump 20 of the present invention is not specified to the above-mentioned construction. In other words, the design of the construction of the vacuum pump 20 may be freely changed if the inlet 27 and the outlet 28 are formed in opposite ends of the vacuum pump 20, and the through hole 25 is formed in the sidewall of the vacuum pump 20.

In the present invention, the vacuum pump 20 is embedded in the negative pressure chamber C in a state in which the inlet 27 and the outlet 28 communicate with the first hole 11 and the second hole 12 of the gripper main body 10, respectively. Here, the vacuum pump 20 directly communicates with the negative pressure chamber C through the through hole 25 that is formed in the sidewall of the body 21. In the drawings, reference numeral 15 denotes a compressed air supply connector that is combined with the first hole 11 such that the connector 15 can communicate with the inlet 27, and reference numeral 29 denotes a typical silencer that is combined with the second hole 12 such that the silencer 29 communicates with the outlet 28.

The suction plate 30 is mounted to the gripper main body 10 using locking bolts, and forms the lower surface of the negative pressure chamber C that is defined in the gripper main body 10. Here, a plurality of suction holes 31 are formed in the surface of the suction plate 30 such that the suction holes 31 communicate with the negative pressure chamber C. The suction plate 30 provides a surface with which the object to be transferred comes into contact, so it is preferred that the suction plate 30 be made of a synthetic resin, such as PEEK (polyetheretherketone) or POM (polyoxymethylene) that is hard and does not produce static elasticity when being solidified.

In the present invention, the location of the vacuum pump inside the negative pressure chamber C may be unstably moved without being stably fixed. To stably fix the location of the vacuum pump 20 inside the negative pressure chamber C, the vacuum gripper device 100 according to the present embodiment further includes a fixing block 40 that can support the vacuum pump 20.

In the present embodiment, two fixing blocks 40 are provided on opposite ends of the negative pressure chamber C, so the fixing blocks 40 can support the opposite ends of the vacuum pump 20 in which the inlet 27 and the outlet 28 are formed in the opposite ends. Here, it is preferred that each of the fixing blocks 40 be provided with a passage channel 41, the first end of which is connected to the inlet 27 or to the outlet 28 of the vacuum pump 20, and the second end of which is connected to the first hole 11 or to the second hole 12 of the gripper main body 10. When the first hole 11 and the second hole 12 are formed in the upper surface of the gripper main body 10 as shown in the drawings, the passage channel 41 is formed as an L-shaped passage channel.

Although each of the fixing blocks 40 of the present embodiment and shown in the accompanying drawings is formed separately from the gripper main body 10 or from the suction plate 30 and is mounted thereto using a plurality of locking bolts 13 that pass through the gripper main body 10, it should be understood that the fixing blocks 40 may be variously designed such that they are integrally formed with the gripper main body 10 or with the suction plate 30 into a single body and protrudes to the interior of the negative pressure chamber C.

To transfer the object, the vacuum gripper device 100 of the present invention is moved. When the suction plate 30 comes into contact with the object P during the movement of the device 100, the sensor 14 shown in FIG. 1 detects the contact of the suction plate 30 with the object, and outputs a system operation signal. In response to the system operation signal output from the sensor 14, compressed air is supplied to the vacuum pump at a high speed, so the vacuum gripper device 100 can grip the object to be transferred P.

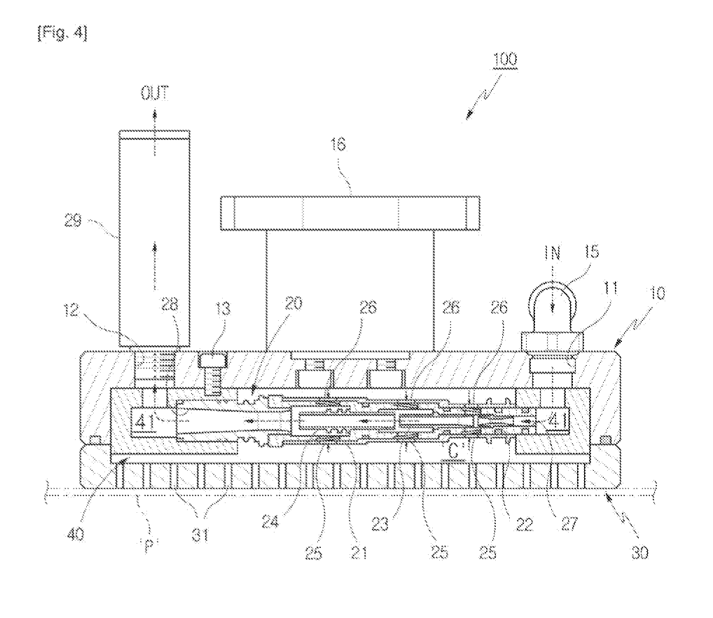

As shown in FIG. 4, in the operation of the vacuum gripper device, compressed air sequentially flows through the first hole 11—the passage channel 41—the inlet 27, and passes through the respective nozzles 22, 23 and 24 at a high speed, and sequentially passes through the outlet 28—the passage channel 41—the second hole 12—the silencer 29 prior to being discharged to the atmosphere (see dotted arrows in the drawings). During the above-mentioned process, air inside the negative pressure chamber C is introduced into the vacuum pump 20 through the through hole 25 (see small arrows in the drawings) and is discharged from the vacuum pump 20 to the atmosphere together with the compressed air. For reference, when air is exhausted from the negative pressure chamber C, the check valve 26 is opened due to an exhaust air pressure. However, when a predetermined level of vacuum pressure and a negative pressure are formed in the negative pressure chamber C, the check valve 26 is closed, thereby functioning to prevent a reverse flow of air through the through hole 25.

When the desired level of vacuum pressure and the negative pressure are produced in the negative pressure chamber C, the object to be transferred P is attached to the surface of the suction plate 30 due to the negative pressure that acts in the suction holes 31. In the above state, both the gripper device 100 and the object to be transferred P can be transferred to a predetermined desired place by a robot arm that is connected to the bracket 16 provided on the upper surface of the gripper main body 10.

As described above, the vacuum gripper device 100 of the present invention includes the vacuum pump 20 in such a way that the vacuum pump 20 is directly embedded in the negative pressure chamber C of the gripper main body 10. Accordingly, during the operation of the vacuum pump 20, the present invention does not cause any vacuum loss, and forms a desired level of vacuum pressure quickly. Further, the vacuum gripper device of the present invention can be designed compactly and safely although the device includes the vacuum pump 20.

1. A vacuum gripper device, comprising:
a gripper main body forming therein a negative pressure chamber by being combined with a suction plate, wherein a first hole and a second hole are formed in an upper surface of the gripper main body at respective locations spaced apart from each other such that the first and second holes communicate with the negative pressure chamber;
a vacuum pump operated by compressed air supplied thereto at a high speed, and installed in the negative pressure chamber in such a way that an inlet and an outlet of the vacuum pump are connected to the first and second holes of the gripper main body, respectively, wherein the vacuum pump directly communicates with the negative pressure chamber through a through hole formed in a sidewall of the vacuum pump; and
the suction plate forming a lower surface of the negative pressure chamber, with a plurality of suction holes formed in a surface of the suction plate such that the suction holes communicate with the negative pressure chamber.

2. The vacuum gripper device as set forth in claim 1, wherein the gripper main body is provided with at least one recessed part in a side surface thereof, with a sensor provided in the recessed part so as to detect an approach or contact of an object to be transferred.

3. The vacuum gripper device as set forth in claim 1, further comprising:
fixing blocks provided on opposite ends of the negative pressure chamber so as to support an inlet end and an outlet end of the vacuum pump.

4. The vacuum gripper device as set forth in claim 3, wherein each of the fixing blocks is provided with a passage channel, a first end of which is connected to the inlet or to the outlet of the vacuum pump, and a second end of which is connected to the first hole or to the second hole of the gripper main body.

5. The vacuum gripper device as set forth in claim 4, wherein the first and second holes are formed in the upper surface of the gripper main body, and the passage channel of each of the fixing blocks is formed as an L-shaped passage channel.
